(19) United States
(12) Patent Application Publication
(10) Pub. No.: US 2006/0085595 A1
(43) Pub. Date: Apr. 20, 2006

(54) Identifying performance affecting causes in a data storage system

(76) Inventor: Alastair Michael Slater, Malmesbury (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/243,089

(22) Filed: Oct. 4, 2005

(30) Foreign Application Priority Data
Oct. 14, 2004 (GB) 0422823.5

(51) Int. Cl. G06F 12/00; G06F 3/00

(52) U.S. Cl. 711/114; 711/170; 710/17; 710/18; 710/19

(57) ABSTRACT

A data library (110) has a plurality of media data transfer drives (204) and a plurality of media locations (212). The library transfers data to/from a data storage system comprising a plurality of other data storage components (103). The data library is configured to determine possible causes affecting performance of the data storage system and comprises: means for obtaining characteristics of data being transferred in the data storage system and/or obtaining characteristics of data transfer in the data storage system; means for processing the obtained data to produce an indication of whether a possible cause affecting data storage system performance relates to one or more said storage system components and/or characteristics of the data being transferred, and means for producing an output relating to at least some of the results of the processing.

### FIELD OF THE INVENTION

The present invention relates to identifying performance affecting causes in a data storage system.

### BACKGROUND TO THE INVENTION

The capacity of data storage systems continues to increase to meet the demands of users. In the past, a stand-alone tape drive would typically have been used by a business to back up data stored in all their computers. More recently, data libraries have become more widely used because of their greater capacity. A data library (normally a tape library) comprises several tape drives and many more media slots. Magnetic tape media are stored in the media slots and are transferred to a drive by a robotic mechanism as required for read/write operations.

Another development which is often used by large organisations with a great amount of data to store is the installation of a Storage Area Network (SAN). A SAN typically comprises optical or copper connections linking individual computers and a data centre. These connections can be American National Standards Institute (ANSI) fibre channels that are dedicated for transmitting data to/from the data centre and are separate from the data transmission network that is used for general communication between networked computers.

FIG. 1 illustrates schematically an example of a SAN. A plurality of individual computers/servers 102 each have a respective storage device, such as a hard drive 103, which may be an external disk array or a single spindle disk. Each server 102 is connected to a switch 104 by means of a fibre channel. A fibre channel leads from the switch 104 to a data centre 106, which can include an array of discs 108 and a tape library 110, for example. In the example of FIG. 1, the switch 104 is shown as a component that is separate from and external to the data centre 106, but in other SANs the switch may be located inside the data centre.

As the complexity of storage systems has increased, identifying faults and improving performance of such systems has also become more difficult. Manufacturers of data storage components such as tape drives usually provide information regarding the expected performance of the unit and if a user believes that the actual performance of the system in use is not the same as these advertised performance figures then he will want to find a way to achieve them, or at least find out why the performance is not as good as expected. However, in a storage system comprising several components of different types, it can be difficult to identify which one(s) is/are responsible for the disappointing performance.

Typically, in order to try to identify which components of a storage system including a tape library may be responsible for performance below that expected, a technician runs a suite of tools, such as Hewlett-Packard “StorageWorks Library and Tape Tools”, and then refers to a guide document (such as “HP Surestore and StorageWorks—Performance Troubleshooting and Using Performance Assessment Tools”, currently available via http://h20000.www2.hp.com/bizsupport/TechSupport/Document.jsp?objectID=lpq50460) in view of the results provided by the tools to try to identify which elements require attention in order to improve performance. This procedure requires the user to have a relatively high level of technical knowledge. Also, such tools need to be installed and executed on a server in the network and many users do not wish to download or install such tools on their servers. Other typical disadvantages of such tools include that they may be invasive and/or require writeable tape media to operate (which may not be available in all tape libraries). Further, in some situations this solution may not be viable. For example, in some data centres the installation of vendor-specific software may not be allowed and so in this case there may be no way for a user to measure the performance of the data storage system in order to identify possible problem areas. Therefore, there are a significant number of data storage systems where this approach is not usable.

Software packages have been developed in an attempt to partly automate the performance monitoring and problem identifying procedure. One example is “WysDM for Backups” produced by SysDM of New York, USA. This application is intended to highlight potential problems that lead to degradation of performance. However, such existing applications need to be run on a dedicated server and so can also result in the problems discussed above. Advanced Digital Information Corporation of Redmond, Wash., USA, describe the “Scalar i2000” tape library, which takes another approach. Here, the tape library itself includes some performance monitoring functionality, the results of which are displayed to the user on a small screen on the housing of the library. Suggested performance optimisations provided by the Scalar i2000 tape library relate to command queuing and data pre-fetching.

### SUMMARY OF THE INVENTION

According to a first aspect of the present invention there is provided a data storage system configured to identify performance affecting causes, the data storage system comprising a data library and a plurality of other data storage components, the data library having a plurality of media data transfer drives and a plurality of media locations and being in communication with the other components, the system further comprising:

means in the data library for obtaining characteristics of data being transferred in the data storage system and/or means in the data library for obtaining characteristics of data transfer in the data storage system;

means for processing the obtained data to produce an indication of whether a cause affecting performance of the data storage system relates to one or more of said storage system components and/or characteristics of the data being transferred, and

means for producing an output relating to at least some of the results of the processing.

According to another aspect there is provided a method of identifying performance affecting causes in a data storage system comprising a data library and a plurality of other data storage components, the data library having a plurality of media data transfer drives and a plurality of media locations and being in communication with the other components, the method comprising:

obtaining characteristics of data being transferred in the data storage system using a processor located in the data library and/or obtaining characteristics of data transfer in the data storage system using a processor located in the data library;

processing the obtained data to produce an indication of whether a cause affecting performance of the data storage system relates to one or more of said data storage system components and/or characteristics of the data being transferred, and

producing an output relating to at least some of the results of the processing.

According to a further aspect there is provided a computer program product configured to make a computer execute a procedure to identify performance affecting causes in a data storage system comprising a data library and a plurality of other data storage components, :the data library having a plurality of media data transfer drives and a plurality of media locations and being in communication with the other components, the procedure comprising:

obtain characteristics of data being transferred in the data storage system using a processor located in the data library and/or obtain characteristics of data transfer in the data storage system using a processor located in the data library;

process the obtained data to produce an indication of whether a cause affecting performance of the data storage system relates to one or more of said data storage system components and/or characteristics of the data being transferred, and

produce an output relating to at least some of the results of the processing.

It will be understood that the computer program may be divided into modules for execution on separate processors.

According to yet another aspect there is provided a data library processor operable in use to identify performance affecting causes of a data storage system, the data storage system comprising a data library and a plurality of other data storage components, the data library having a plurality of media data transfer drives and a plurality of media locations and being in communication with the other components, said data library processor being configured to:

obtain characteristics of data being transferred in the data storage system and/or obtain characteristics of data transfer in the data storage system;

process the obtained data to produce an indication of whether a cause affecting performance of the data storage system relates to one or more of said storage system components and/or characteristics of the data being transferred, and

produce an output relating to at least some of the results of the processing.

According to another aspect there is provided a data library having a plurality of media data transfer drives and a plurality of media locations, the library being in communication with a data storage system comprising a plurality of other data storage components, the data library configured to determine causes affecting performance of the data storage system and comprising:

means in the data library for obtaining characteristics of data being transferred in the data storage system and/or means in the data library for obtaining characteristics of data transfer in the data storage system;

means for processing the obtained data to produce an indication of whether a cause affecting performance of the data storage system relates to one or more of said storage system components and/or characteristics of the data being transferred, and

means for producing an output relating to at least some of the results of the processing.

According to a further aspect there is provided a data storage system configured to identify performance affecting causes, the data storage system comprising a tape library and a plurality of other data storage components external to the library, the library having a plurality of tape data transfer drives and a plurality of tape locations and being in communication with the other components, the system further comprising:

a processor located in a router or interface manager component of the data library, the processor being configured to obtain characteristics of data being transferred in the data storage system and/or a processor in the data library configured to obtain characteristics of data transfer in the data storage system, wherein the processor processes the obtained data to produce an indication of whether a cause affecting performance of the data storage system relates to one or more of said storage system components and/or characteristics of the data being transferred, and the processor produces an output relating to at least some of the results of the processing.

According to a further aspect there is provided a tape library having a plurality of tape drives, a plurality of media slots and a controller for transferring tape media between a said media slot and a said tape drive, the tape library being in communication with a data storage system comprising a plurality of other data storage components, the tape library configured to determine causes affecting performance of the data storage system and comprising:

a router or interface manager in the data library that obtains characteristics of data being transferred in the data storage system and/or a processor in the data library that obtains characteristics of data transfer in the data storage system, the router or interface manager further processing the obtained data to produce an indication of whether a cause affecting performance of the data storage system relates to one or more of said storage system components and/or characteristics of the data being transferred, and

a device that produces an output relating to at least some of the results of the processing.

According to yet another aspect there is provided a tape library having a plurality of tape drives, a plurality of media slots and a controller for transferring tape media between a said media slot and a said tape drive, the tape library being in communication with a data storage system comprising a plurality of other data storage components, the tape library configured to determine causes affecting performance of the data storage system and comprising:

a processor that obtains characteristics of data being transferred in the data storage system, the processor configured to process the obtained data to identify whether the compressibility of at least some of the data being transferred in the data storage system is affecting performance of the data storage system, and produce an indication of whether the compressibility is affecting the performance of the system.

Whilst the invention has been described above, it extends to any inventive combination of the features set out above or in the following description.

### BRIEF DESCRIPTION OF THE DRAWINGS

The invention may be performed in various ways and, by way of example only, various embodiments will now be described, reference being made to the accompanying drawings, in which:-

FIG. 1 illustrates schematically an example of an existing Storage Area Network;

FIG. 2 illustrates schematically a tape library;

FIG. 3 illustrates schematically general steps performed by an embodiment at least partly implemented on the tape library;

FIG. 4 illustrates schematically steps that can be performed by the embodiment to detect storage system components responsible for delays;

FIG. 5 illustrates schematically another set of steps that can be performed in order to identify storage system components responsible for delays;

FIG. 6 illustrates schematically steps relating to measuring the compressibility of data transferred in the data storage system;

FIG. 7 illustrates schematically another set of steps relating to measuring the compressibility of data transferred in the data storage system;

FIG. 8 illustrates schematically steps that can be performed to seek to determine faulty storage system components, and FIG. 9 illustrates schematically steps that can be used to determine the usage of storage system components.

### DETAILED DESCRIPTION OF THE DRAWINGS

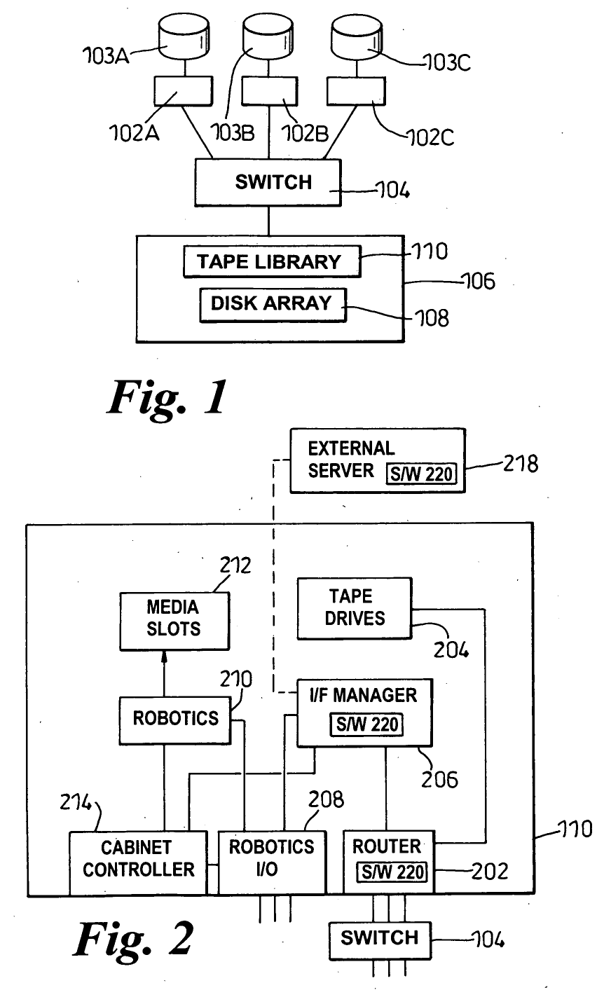

The tape library 110 of FIG. 2 is a component of a data storage system that can also include other components such as those shown in the example SAN of FIG. 1, although it will be appreciated that the embodiments described below can be used in other types of data storage hardware (including, for example, any non-volatile storage medium,such as disk drives, solid state memory or memory cards/sticks) and network configurations. The tape library 110 comprises hardware components commonly included in conventional tape libraries, such as those manufactured by the present applicant, and their function will be well known to the skilled person. The library 110 includes a router 202 that includes a plurality of fibre channel ports used to transfer data to/from a storage system switch 104. The router 202 is sometimes known as an “intelligent controller” and may shield drives located within the library 110 from unwanted SAN traffic, as well as routing wanted traffic. The router is connected to a plurality (e.g. 20) of tape drives 204 by means of a fibre channel or SCSI link. The router 202 is also connected by means of an Ethernet link to an interface manager component 206. Conventionally, the interface manager component derives or stores “rich content” that is used for external monitoring of library behaviour and error conditions, as well as for setting up and configuring the router 202. The interface manager component is connected to a robotics input/output component 208. The input/output component 208 includes fibre channel ports for communication with storage system components external to the library, as well as a link to robotic tape transfer component 210 and a cabinet controller 214. The robotics controller 210 is used to transfer tape media between a plurality (e.g. 100) of media slots 212 and tape drives 204 as required.

The interface manager 206 may be connected to an external server 218 by means of an Ethernet link. Such external servers are sometimes used with tape libraries to remotely access management functions, typically by means of a WWW-based interface, or by means of some other appropriate software such as SMIS (as disclosed by the Storage Network Industry Association, http://www.snia.org) or Simple Network Management Protocol (SNMP). Typically, software resident on an external server (e.g. 102A) is used to provide back-up and restore functions for the data library 110, although there may be some data movement functionality built into the router 202, e.g. known extended copy (“Xcopy”) functionality.

In some embodiments, the processor and memory of the interface manager component 206 are configured to execute software 220 that performs some or all of the steps described herein. In an alternative embodiment, the processor and memory of the router 202 executes the software 220. The software 220 running on components 202 or 206 may perform all the steps described below, or only some of them, in particular the data and data transfer characteristics logging steps, with the other steps being performed by processors on other components. For example, the software running on components 204 or 206 may log, store and analyse data and transfer data relating to at least some of the results of the analysis to software running on the external server 218 for output, although it will be appreciated that this is optional. The WWW interface of the external server 218 can also be used to allow a user to configure aspects of the software 220, including switching its operation on/off as desired.

Using existing tape library components such as the router or interface manager makes efficient use of resources and can mean that additional/external hardware may not be required to run the software 220. Further, having at least the logging (and usually the analysis) steps performed by components located within the tape library (and storing the associated data therein) means that additional software does not have to be downloaded onto or executed by servers 102 to assist with performance monitoring and problem identifying, which mitigates the problems associated with installing software for these purposes on the external servers.

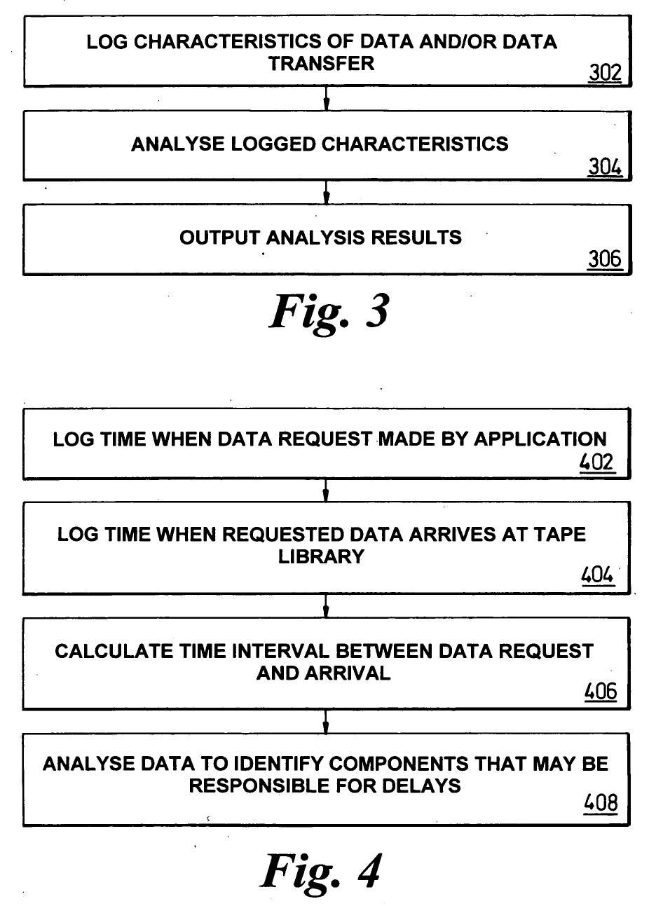

Turning to FIG. 3, there is shown an example of the general steps that can be performed by the software 220. Step 302 comprises recording characteristics of data transferred to the tape library and/or the characteristics of the data transfer itself. Examples of the characteristics that may be recorded will be given below, but it will be understood that these examples are not intended to be exhaustive. Further, it will be appreciated that the way in which the characteristics are recorded and the data structures used to store (at least temporarily in a random access memory of a tape library component and/or in a non-volatile storage device in the tape library) the recorded data can take many forms.

The characteristics can be recorded by the software 220 by means of techniques similar to those used in known protocol analysers to provide the software with information relating to data being transferred in the storage system, both in the tape library itself and by other components of the data storage system. This can be achieved by logging events taking place over fibre channels and/or at the router (bus) of the tape library. For example, known SCSI protocol analysers can decode data packets being transferred to obtain information regarding Command Descriptor Blocks and parameters. The software 220 can operate in a similar manner to record a sequence of I/O commands (typically data read/write requests associated with specific storage system components) and/or (all or some of) the corresponding data itself and/or characteristics of the data being transferred, e.g. its size. The software 220 may also record characteristics by performing various log retrieval operations on data storage system components such as the tape drives 204 of the tape library (e.g. by issuing SCSI log sense commands to obtain information regarding the compressibility of data being transferred and/or media error rates) at pre-defined or user-selected intervals to build up log trends over time.

Further, the software 220 can also log the time when each command was sent and the time when data was transferred as a result of the command. One way of logging such a “timestamp” for an I/O command is noting the time when the I/O phase of the command occurred relative to an absolute time when the analyser component of the software 220 started operating. Typical characteristics recorded include the time when an I/O command occurred; the compressibility of the data being transferred in response to an I/O command and the time when the data arrives at the data library. Having data representing a broad range of characteristics relating:to the data and/or data transfer available for analysis means that the software 220 is more likely to correctly identify factors that affect performance of the data storage system and so can increase the chances of a user improving the performance if required.

At step 304 the characteristics recorded at step 302 are analysed. This analysis can be performed by the same processor that performed the logging step 302 or it may take place on another processor. For example, the router 202 could carry out the logging steps 302 and transfer the data to software running on the interface manager 206 for analysis.

At step 306 at least some of the results of the analysis are output. Again, a different processor may be used for this step. Also, the nature of the output can take many forms. For example, it can be graphical and/or textual for viewing by a user. It may include an indication of which characteristics (or factors associated with them) affect performance of the data storage system and/or an indication of what can be done to improve performance. The output may be displayed directly to the user during or immediately after analysis, or data relating to the analysis results could be transferred, e.g. as a file by email, to another component for subsequent viewing or other use.

FIGS. 4 to 9 illustrate specific examples of how the steps shown in FIG. 3 can be implemented. It will be understood that all or some of the operations shown in the following Figures may be performed by embodiments of the software 220. For example, the user may be able to select which one(s) of the operations are to be performed.

FIG. 4 illustrates schematically an example of steps that can be performed by the software in order to identify one or more components of the storage system that transfer data to the tape library at a relatively low rate compared with other components of the system. As will be known to the skilled person, tape drives include a buffer that receives and temporarily stores data to be written to tape. Normally, a tape write operation will only take place once there is a certain minimum amount of data in the buffer. Therefore, the rate at which data is written to the tape depends upon the rate at which data is received by the buffer. Delays in the transfer of data from a storage system component to the tape library will therefore affect the entire tape writing operation, e.g. during a back-up procedure. Also, delays in transfer of data from the tape library to other system components, e.g. during a restore procedure, will also affect the overall operation of the system. Information regarding which component may be the “slow” one can be relayed to a user to assist in improving performance of the entire storage system.

At step 402 the software logs the time an I/O command is made by the backup application running on an external server, e.g. 102A, and details of the command. The I/O command may, for example, request a specific block of data from one of the hard drives 103. At step 404 the software 220 logs the time the requested data arrives at the tape library (e.g. at the router 202) in response to the command. The data storage system component associated with the data arriving at the library may be identified by the fibre channel port that is used, typically by means of a mapping that can already be stored within or derived by the library that denotes the port fibre channel worldwide name to host fibre channel worldwide name. At step 406 the time interval between when the command requesting the data was issued by the backup application (logged at step 402) and the time when the requested data actually arrived at the tape library (logged at step 404) is calculated. As with other logging steps described herein, the steps 402 to 406 may be repeated for a sequence of I/O commands, e.g. continuously or periodically whilst the software 220 is activated, or for a certain (possibly user-configurable) period of time following a specific instruction by the user.

At step 408 the logged data is analysed to try to identify which components may be responsible for tape write operation delays. As with the other operations shown in the following Figures, the analysis may take place at various times, for example it may be carried out periodically (possibly at user-defined intervals); when the software 220 is de-activated by the user or in response to a specific instruction by the user.

Logging data as described above allows a picture to be built up of which storage system components are slow to complete data transfer requests. For example, the total time interval resulting from I/O commands directed to each storage system component used during the logging step can be calculated by adding up the individual time intervals associated with each component. Therefore, even though the individual intervals recorded for a particular component may not seem significant when considered in isolation, the overall performance of the component on the storage system may still be affected. Storage system components that may be responsible for delays in this way can be identified by using the data to find ones that have a total time interval greater than a threshold (which may be configured by the user). The output resulting from this analysis may be an indication that the data transfer rate of a particular component, e.g. server 102A (possibly denoted by its world-wide name or other identifier), appears to be slow compared with other components. The user can then look at the identified server in more detail and see how its performance could be improved, for example by upgrading or de-fragmenting its hard drive 103A.

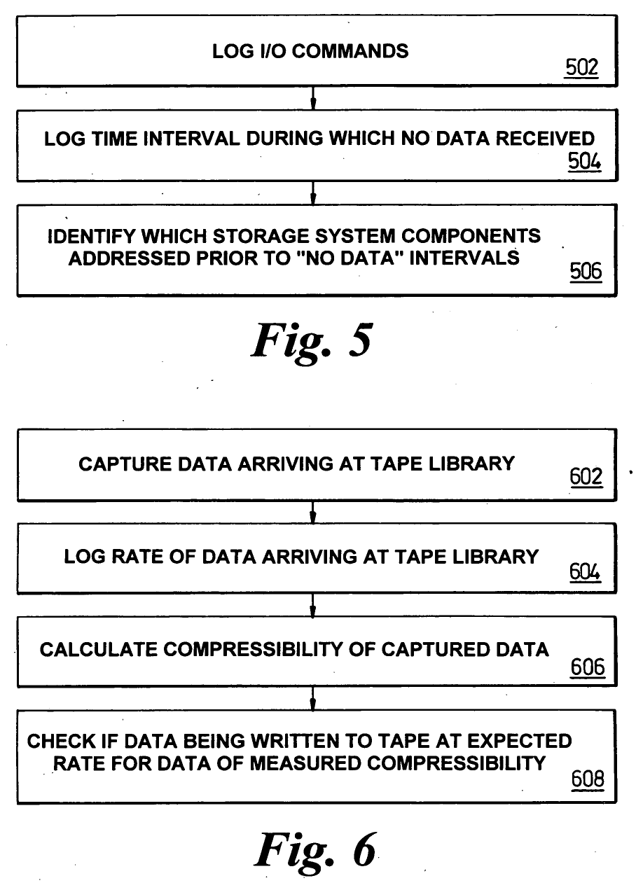

The steps illustrated schematically in FIG. 5 are an example of how to identify which storage system components may be responsible for delays in the tape writing process by not transferring data when data transfer is expected. These steps are intended to detect intervals when no data is being received at (or transferred from) the tape library and identify (using the data logged regarding commands that lead up to the delay) which storage system component may be responsible for the lack of data transfer. In such cases, when data transfer does take place, performance may be at or close to what is advertised by a component manufacturer, but “gaps” when no data transfer occur and these result in tape write operation delays (during a back-up procedure, for example) or read operation delays (during a restore procedure for example).

At step 502 the software 220 starts to log I/O commands. Again, this logging can be repeated whilst the software 220 is activated, or for a certain (possibly user-configurable) period of time following a specific request by the user. At step 504 the software detects a lack of data arriving at the tape library, e.g. at the router 202, and measures the length of time whilst there is a “gap” in data transfer. This can be done, for example, by starting a timer when no data arriving at the router is first detected and stopping the timer when data is subsequently received, or determining the time interval between when data not arriving at the router is first detected and the time when data is next received.

At step 506, the software uses the data logged at steps 502 and 504 to identify which storage system components were addressed before each significant time interval during which no data was received. A significant time interval may correspond to one greater than a threshold value or one within a specific range (possibly set by the user) that indicates a period of inactivity when data transfer would be expected. Typically, the period will be within a range of a few seconds/minutes, as longer periods may not necessarily be indicative of a delay, e.g. a data library may only be used every 12 or 24 hours for a backup operation and remain inactive at other times. The output resulting from this analysis can be an indication that data requests from a particular server resulted in long period of data transfer inactivity, which the user can then investigate.

The steps of FIG. 6 are an example of ones intended to detect whether tape write operation performance is being limited by the compressibility of the data being transferred. In some cases, data will be transferred to the tape library at (or close to) the rate advertised by the manufacturer, but many users expect compression hardware in the tape drive to compress all incoming data at a minimum ratio, e.g. 2:1, and therefore anticipate faster performance than is actually occurring. However, if significant compression at the tape drive does not take place (for example, due to the data arriving at the tape library having been already compressed by software compression algorithms when being stored on a server hard drive 103) then it will not be possible to meet this user expectation. Further, in some cases the performance of the tape drive may degrade further when it receives data that has already been compressed because an effort to compress it further by the hardware can result in the data being expanded before it is written to the tape.

At step 602 the software 220 captures data arriving at the tape library 110. This may be a small sample, e.g. one or more individual blocks, or it may be a larger stream of data arriving over a longer period of time. The rate at which data arrives at the tape library is also logged at step 604. These logging steps can be repeated whilst the software 220 is activated, or for a certain (possibly user-configurable) period of time following a specific request by the user. At step 606 the compressibility of the captured incoming data is calculated. Typically, this is done by processing the data using a compression algorithm substantially identical to the one used by the tape drive hardware, which gives an indication of the how incoming data arriving at the router is (or will be) compressed when written to tape. Alternatively, a SCSI log sense command (included in known command libraries such as scsi/scsi_ioctl.h) may be used to obtain data compressibility information from a log page, although it may be undesirable to use this latter option in some tape devices as frequent retrieval from the log page can affect performance.

At step 608, the software checks whether the data is being written to the tape at the rate which is expected for data of the actual measured compressibility. That is, the software checks whether the rate at which data is arriving at the tape library is about the same as the maximum rate at which data can be written to the tape. If the incoming data cannot be (significantly) compressed then the data write rate will not be greater than the actual rate at which data is received at the tape library and no performance improvement can be expected. Alternatively or additionally, the software 220 may check at step 608 if the data write rate reported by the tape drive itself corresponds to the write rate that is expected (e.g. according to manufacturer's data sheet) when data of the measured compressibility arrives at the data library at the measured arrival rate.

The resulting output may be an indication of whether data writing is taking place at the expected rate.. The output may also include suggestion that software compression algorithms on the servers should not be used (possibly using data relating to the captured data to indicate which server transferred the most data that was already compressed and/or an indication of the transferred files that contained compressed data. Data representing a graph illustrating the compressibility of incoming data over a period of time (or according to another factor such as the compressibility of data transferred from each storage system component) may also be output. In one embodiment the output includes a graph representing the compressibility of the data over a period of time; the performance (e.g. transfer rate in MB/s) measured in terms of arrival of data at the tape library and the performance measured in terms of writing of the data to the tape.

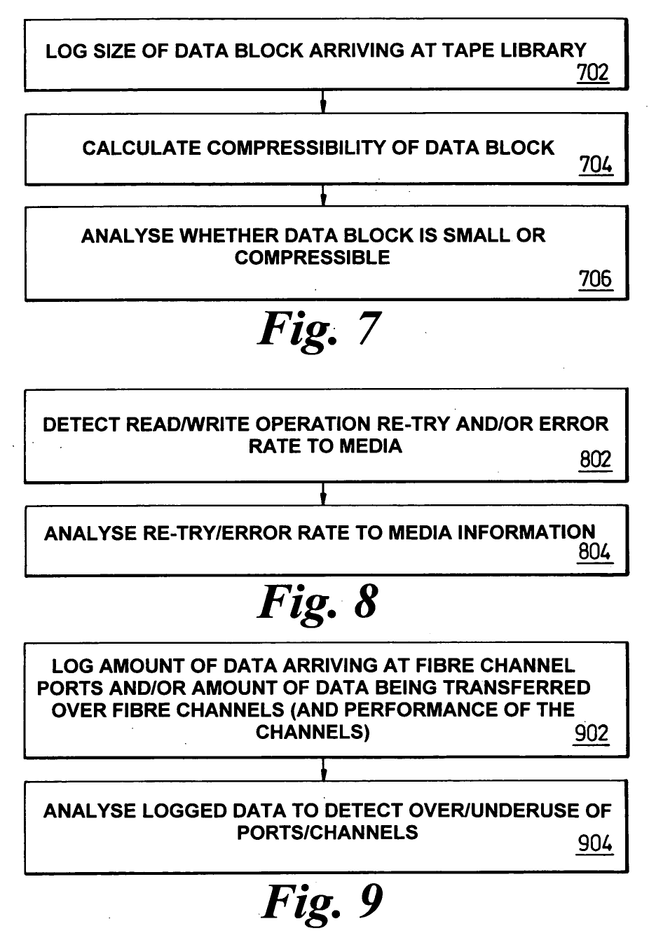

The steps of FIG. 7 are an example of how to identify whether the configuration of a software application that uses the data storage system affects the performance of the system. Although software applications (e.g. back-up and restore applications, also known as “data protection” applications) tend to be initially configured with the manufacturer's recommended settings that will result in optimal (or near) performance, sometimes users change these settings, which can result in degraded performance. An example of such a setting is the size of data blocks that the application transfers to the tape drives within the library, although it will be appreciated that other settings (e.g. settings relating to the correct type of hardware configurations) may also affect performance of the data storage system. If small data blocks are transferred then the tape drive buffer will take a longer time to fill than if blocks of a larger size are used, thereby decreasing the overall rate at which tape write operations take place. Further, the write operation can be further delayed if the small data blocks are compressed by the tape drive hardware before being written to the tape from the buffer.

At step 702 the size of a data block arriving at the tape library is logged. As with other logging operations, this can be repeated whilst the software 220 is activated, or for a certain (possibly user-configurable) period of time following a specific request by the user. Optionally, at step 704 the compressibility of the data block may be calculated. Again, this can be achieved by processing the data blocks using a compression algorithm substantially identical to that used by the tape drive hardware, or by obtaining data using the aforementioned SCSI log sense command, for example. At step 706 the software 220 analyses whether the data block size is considered to be small (e.g. less than a threshold, possibly one set by the user, or derived from the use of test/model data as discussed below). The software may also check if the data block is compressible (for example, compressible at a minimum ratio). Dependant upon results of these checks, a suitable output can be an indication that performance may be improved by increasing the size of blocks dealt with by the application responsible for transferring the data blocks, or simply that the block size for each input/output operation is considered to be too small.

The steps illustrated in FIG. 8 are an example of how to identify data storage system components, such as a particular ones of the tape drives 204 or media slots 212 (or the actual media used by the components) that may have physical faults. At step 802 the software 220 detects a read/write operation retry (or failure). This retry is logged, along with information identifying the tape, tape drive and/or media slot in which the tape was stored prior to being used. Alternatively or additionally, the “error rate to media” of each tape media can be logged, typically by obtaining information from a tape drive log page using, for example, a SCSI log sense command over either the server interface or its automation (serial port) interface. Further, increases in the error rate of a particular medium as it is moved through the data storage system for I/O operations can be recorded. This may be achieved by recording the identifier of a medium, the identifier of each drive in which it is used, along with the error rate of the tape after/when it is by the drive. The identifier of each media slot in which the tape stored can also be recorded, along with the error rate of the tape (immediately) after it leaves the slot. This logging can be repeated whilst the software 220 is activated, or for a certain (possibly user-configurable) period of time following a specific request by the user. A “history” of such error rates and/or re-tries and the associated slot/drive tracking can therefore be built up and stored for analysis.

At step 804 an analysis is carried out on the data recorded at step 802. For example, if the logged information indicates that read/write operations for a particular tape (which can be identified by its manufacturer's unique serial number, or via an external application's media identifier) had to be re-tried on several occasions (e.g. greater than a threshold number, possibly set by the user), or that the error rate is greater than a threshold (possibly user-defined), then this can be used to deduce that that particular tape is faulty and needs to be replaced. Also, if the analysis indicates that tapes that have been stored in a particular media slot (or used by a particular tape drive) subsequently require several retries or an increased error rate (but did not require re-tries or had a lower error rate before being presented to the particular slot/drive) then this could be taken to indicate that the media slot (or tape drive) is faulty and responsible for damaging tapes. The output of this analysis can be an indication of which tape, tape drive and/or media slot may be faulty. It is also possible for this detection of faulty components to be implemented for components outside the tape library, e.g. by interrogating the fibre channel switch 104 for protocol type errors of its port(s).

The steps illustrated in FIG. 9 are examples of how to indicate whether certain the components of the data storage system are being overused or underused. Data transfer tends to be more efficient if the data is more evenly distributed over system components. The components may include connections such as fibre channels between (or ports in) components like the routers and/or external switches, or manager/intelligent controller components of the tape library. At step 902 the amount of data arriving at a set (e.g. all of them or a predefined or user-selected set) of fibre channel ports of the router 216 over a period of time (possibly user-configurable) is logged. Alternatively or additionally, data relating to the (optical/wire) performance (e.g. 1 Gbit/s or 2 Gbit/s at least) of a set (e.g. all of them or a predefined or user-selected set) of fibre channels can be logged at step 902, as well as the amount of data being transferred over the channels over a period of time (possibly user-configurable).

The information relating to the amount of data that arrived at the set of ports is analysed at step 904 to see whether a greater amount of data arrived at particular ports during the time period, and/or whether ports were underused (or unused), possibly in comparison with the over-used ports. The factors used to determine “overuse” and “under-use” of components may vary or may be user configurable. Alternatively or additionally, the analysis of step 904 can determine whether the data transfer capacity/performance of the set of channels is appropriate for the amount of data that is being transferred over them. This analysis can therefore provide an indication of whether a certain fibre channel (typically one used for transferring a great amount of data) should be replaced by one with an increased data transfer capacity and/or an indication of whether a certain fibre channel (typically one used for transferring a relatively small amount of data) should be replaced by one having a lower data transfer capacity, thereby making efficient use of the type of connections used.

The output resulting from this analysis may be an indication of which ports carried a high volume of data and/or which ports carried a low volume of data. The output could include a suggestion that certain external server connectivity settings (or settings of a software application running on an external server) are modified to use the fibre channels that were identified as being underused instead of the ones that were identified as being heavily used, or even that the physical structure of the network should be modified (possibly in a specified manner). Alternatively or additionally, the output can also include a representation (possibly a graph) of the amount of data recorded as being transferred by one or more of the set of channels over the time period and/or a suggestion that particular fibre channels should be replaced with ones having a greater/smaller capacity (due to the recorded usage).

Although the examples described above mainly relate to data being written to the data library, it will be understood that the operations can be adapted to measure the performance of the library when data is read from the library (e.g. during a data restore operation as opposed to a data backup operation). Further, the software 220 can be adapted to carry out the logging and analysis steps during a combination of tape read and write operations. Also, instead of the software always operating on data being transferred during an actual backup/restore operation, the software could be configured to transfer model/test data (possibly using known “good”/substantially error free media and/or storage devices) to assess performance of the data storage system and these performance characteristics can then be stored (preferably in a memory of a component in the tape library) for later use for comparison with performance characteristics of the data storage system using “real” data.

We claim:

1. A data storage system configured to identify performance affecting causes, the data storage system comprising a data library and a plurality of other data storage components, the data library having a plurality of media data transfer drives and a plurality of media locations and being in communication with the other components, the system further comprising:
means in the data library for obtaining characteristics of data being transferred in the data storage system and/or means in the data library for obtaining characteristics of data transfer in the data storage system;
means for processing the obtained data to produce an indication of whether a cause affecting performance of the data storage system relates to one or more of said storage system components and/or characteristics of the data being transferred, and
means for producing an output relating to at least some of the results of the processing.

2. A system according to claim 1, wherein the means for processing the obtained data identifies one or more of the components of the data storage system that transfer data at a relatively slow rate compared with other of the components and the means for producing an output outputs an indication of the one or more identified slow components.

3. A system according to claim 2, wherein the means for processing the obtained data logs a first time when a request for data is initiated and logs a second time when the data transfer request is completed and logs the data storage system component associated with the request, and the means for processing the obtained data calculates a time interval between the first time and the second time.

4. A system according to claim 3, wherein the means for processing the obtained data further adds the time intervals associated with each said data storage system component used to obtain an indication of how fast each said component completes its said data transfer requests.

5. A system according to claim 1, wherein the means for processing the obtained data identifies one or more of the components of the data storage system that does not transfer data when data transfer is expected and the means for producing an output outputs an indication of the one or more identified components.

6. A system according to claim 5, wherein the means in the data library for obtaining characteristics of the data being transferred and/or the means in the data library for obtaining characteristics of the data transfer obtains data relating to data transfer requests and obtains data relating to any time intervals during which no data is received at the data library, and the means for processing the obtained data identifies which said component is associated with a said obtained data transfer request associated with a said time interval during which no data was received.

8. A system according to claim 1, wherein the means for processing the obtained data identifies whether compressibility of at least some of the data being transferred in the data storage system is affecting performance of the data storage system and the means for producing an output outputs an indication of whether or not this is the case.

9. A system according to claim 8, wherein the means in the data library for obtaining characteristics of the data being transferred and/or the means in the data library for obtaining characteristics of the data transfer obtains data relating to compressibility of at least some of the data being transferred and the means for processing the obtained data obtains the rate at which data is received at the data library and compares the obtained data rate with a rate at which data of the obtained compressibility is expected to be written to a said library media transfer drive, and the means for producing an output outputs an indication of a result of the comparison.

10. A system according to claim 8, wherein the means in the data library for obtaining characteristics of the data being transferred and/or the means in the data library for obtaining characteristics of the data transfer obtains data relating to a data arrival rate representing a rate at which data is received at the data library and the means for processing the obtained data obtains a data writing rate representing a rate at which data is being written to a library drive and checks the data writing rate to determine whether data writing is taking place at a rate which is expected for data of the measured compressibility and arrival rate.

11. A system according to claim 1, wherein the means for processing the obtained data identifies whether a software application (e.g. a back-up and/or restore application) that uses the data storage system is configured to transfer data blocks of a size smaller than the maximum block size usable by a said data library media data transfer drive to write to said media in the drive.

12. A system according to claim 11, wherein the means in the data library for obtaining characteristics of the data being transferred and/or the means in the data library for obtaining characteristics of the data transfer obtains data relating to a size of data blocks received at the data library and the means for processing the obtained data checks if the data blocks are compressible and checks if the obtained size of the data blocks is below a threshold and, if results of these two checks are positive, then the means for producing an output outputs an indication that the data block size should be increased and/or that the data block size is too small.

13. A system according to claim 1, wherein the means for processing the obtained data identifies any data storage system components and/or media used by the media data transfer drives that have faults that affect the performance of the system and the means for producing an output outputs an indication of the identified data storage system components and/or the media.

14. A system according to claim 1, wherein the means for processing the obtained data identifies whether usage of particular data transfer connections or ports in the data storage system affects the performance of the system and the means for producing an output outputs an indication of whether or not this is the case.

15. A system according to claim 1, wherein the means in the data library for obtaining characteristics of the data being transferred and/or the means in the data library for obtaining characteristics of the data transfer is located in a router or an interface manager component of the data library.

16. A method of identifying performance affecting causes in a data storage system comprising a data library and a plurality of other data storage components, the data library having a plurality of media data transfer drives and a plurality of media locations and being in communication with the other components, the method comprising:
obtaining characteristics of data being transferred in the data storage system using a processor located in the data library and/or obtaining characteristics of data transfer in the data storage system using a processor located in the data library;
processing the obtained data to produce an indication of whether a cause affecting performance of the data storage system relates to one or more of said data storage system components and/or characteristics of the data being transferred, and
producing an output relating to at least some of the results of the processing.

17. A computer program product configured to make a computer execute a procedure to identify performance affecting causes in a data storage system comprising a data library and a plurality of other data storage components, the data library having a plurality of media data transfer drives and a plurality of media locations and being in communication with the other components, the procedure comprising:
obtain characteristics of data being transferred in the data storage system using a processor located in the data library and/or obtain characteristics of data transfer in the data storage system using a processor located in the data library;
process the obtained data to produce an indication of whether a cause affecting performance of the data storage system relates to one or more of said data storage system components and/or characteristics of the data being transferred, and
produce an output relating to at least some of the results of the processing.

18. A data library processor operable in use to identify performance affecting causes of a data storage system, the data storage system comprising a data library and a plurality of other data storage components, the data library having a plurality of media data transfer drives and a plurality of media locations and being in communication with the other components, said data library processor being configured to:
obtain characteristics of data being transferred in the data storage system and/or obtain characteristics of data transfer in the data storage system;
process the obtained data to produce an indication of whether a cause affecting performance of the data storage system relates to one or more of said storage system components and/or characteristics of the data being transferred, and
produce an output relating to at least some of the results of the processing.

19. A data library having a plurality of media data transfer drives and a plurality of media locations, the library being in communication with a data storage system comprising a plurality of other data storage components, the data library configured to determine causes affecting performance of the data storage system and comprising:
means in the data library for obtaining characteristics of data being transferred in the data storage system and/or means in the data library for obtaining characteristics of data transfer in the data storage system;
means for processing the obtained data to produce an indication of whether a cause affecting performance of the data storage system relates to one or more of said storage system components and/or characteristics of the data being transferred, and
means for producing an output relating to at least some of the results of the processing.

20. A data storage system configured to identify performance affecting causes, the data storage system comprising a tape library and a plurality of other data storage components external to the library, the library having a plurality of tape data transfer drives and a plurality of tape locations and being in communication with the other components, the system further comprising:
a processor located in a router or interface manager component of the data library, the processor being configured to obtain characteristics of data being transferred in the data storage system and/or a processor in the data library configured to obtain characteristics of data transfer in the data storage system, wherein the processor processes the obtained data to produce an indication of whether a cause affecting performance of the data storage system relates to one or more of said storage system components and/or characteristics of the data being transferred, and the processor produces an output relating to at least some of the results of the processing.

21. A tape library having a plurality of tape drives, a plurality of media slots and a controller for transferring tape media between a said media slot and a said tape drive, the tape library being in communication with a data storage system comprising a plurality of other data storage components, the tape library configured to determine causes affecting performance of the data storage system and comprising:
a router or interface manager in the data library that obtains characteristics of data being transferred in the data storage system and/or a processor in the data library that obtains characteristics of data transfer in the data storage system, the router or interface manager further processing the obtained data to produce an indication of whether a cause affecting performance of the data storage system relates to one or more of said storage system components and/or characteristics of the data being transferred, and
a device that produces an output relating to at least some of the results of the processing.

22. A tape library having a plurality of tape drives, a plurality of media slots and a controller for transferring tape media between a said media slot and a said tape drive, the tape library being in communication with a data storage system comprising a plurality of other data storage components, the tape library configured to determine causes affecting performance of the data storage system and comprising:
a processor that obtains characteristics of data being transferred in the data storage system, the processor configured to process the obtained data to identify whether the compressibility of at least some of the data being transferred in the data storage system is affecting performance of the data storage system, and produce an indication of whether the compressibility is affecting the performance of the system.
